(19) United States
(12) Patent Application Publication
(10) Pub. No.: US 2019/0171603 A1
(43) Pub. Date: Jun. 6, 2019

(54) EXTENDED AND EXPANDED USB 3.1 HUB

(71) Applicant: IOI Technology Corporation, New Taipei City (TW)

(72) Inventor: Hua-Kang WU, New Taipei City (TW)

(21) Appl. No.: 16/102,763

(22) Filed: Aug. 14, 2018

(30) Foreign Application Priority Data
Dec. 1, 2017 (TW) 106217958

(51) Int. Cl. G06F 13/40; G06F 13/38

(52) U.S. Cl. CPC G06F 13/4022; G06F 2213/0042; G06F 13/382; G06F 13/4068

(57) ABSTRACT

An extended and expanded USB 3.1 hub includes a housing, a signal transmission module, a first connector and a second connector. The signal transmission module is installed in the housing. The first connector is installed on the housing and electrically connected to the signal transmission module. The second connector is installed on the housing and electrically connected to the signal transmission module. The second connector is used to connect an electronic device, and the first connector and the second connector are both USB 3.1 connectors.

### RELATED APPLICATIONS

This application claims priority to Taiwan Application Serial Number 106217958, filed Dec. 1, 2017, which is herein incorporated by reference.

### TECHNICAL FIELD

The present disclosure generally relates to an extended and expanded HUB. More particularly, the present disclosure relates to an extended and expanded USB 3.1 hub.

### BACKGROUND

With the development of science and technology, the universal serial bus (USB) has been widely used in the computer industry. The universal serial bus can be connected between a host and an electronic device, which is used for data exchange between the host and the electronic device.

The universal serial bus has developed from the past USB 2.0, USB 3.0 (also named USB 3.1 Gen 1) to the newer USB 3.1 Gen 2. Furthermore, a new USB Type-C connector can provide more and more functions. In addition to the data transmission function, the USB Type-C connector also has a power delivery (PD) function, but currently the USB 3.1 Type-C standard transmission cable on the market is generally less than 1.5M in length. According to the USB Type-C Specification published by the USB Implementers Forum (USB-IF), the length of the USB 3.1 Type-C to Type-C transmission cable is less than or equal to 2M. However, such a length cannot meet a long distance transmission requirement. How to extend the transmission distance of USB 3.1 will be a problem faced by those skilled in the art.

Therefore, there is a need to extend the USB 3.1 transmission distance so as to further increase the user's convenience in using the USB device.

### SUMMARY

One objective of the embodiments of the present invention is to provide an extended and expanded USB 3.1 hub so as to increase the USB signal transmission capability.

To achieve these and other advantages and in accordance with the objective of the embodiments of the present invention, as the embodiment broadly describes herein, the embodiments of the present invention provides an extended and expanded USB 3.1 hub includes a housing, a signal transmission module installed in the housing, a first connector installed on the housing to electrically connect to the signal transmission module, and a second connector installed on the housing to electrically connect to the signal transmission module. The second connector is used for connecting an electronic device, and the first connector and the second connector are Type-C connectors.

In one embodiment, the first connector and the second connector are USB 3.1 Type-C connectors.

In one embodiment, the signal transmission module includes a multiplexer (MUX) electrically connecting to the first connector, a signal transmission chip electrically connecting to the multiplexer, and a switching regulator electrically connecting to the signal transmission chip and the multiplexer. In addition, the multiplexer is a multiplexer with configuration channel logic (CCL) control.

In one embodiment, the signal transmission chip includes an upstream facing port, a USB 2.0 hub circuit electrically connecting to the upstream facing port, a controller electrically connecting to the USB 2.0 hub circuit, a USB 3.1 hub circuit electrically connecting to the controller and the upstream facing port, a first downstream facing port electrically connecting to the USB 2.0 hub circuit and the USB 3.1 hub circuit, and a second downstream facing port electrically connecting to the USB 2.0 hub circuit and the USB 3.1 hub circuit.

In addition, the first connector and the second connector respectively comprise A1-A12 pins and B1-B12 pins.

In one embodiment, the A4, A9, B4 and B9 pins of the first connector electrically connect to the A4, A9, B4 and B9 pins of the second connector, and further electrically connect to the switching regulator.

In one embodiment, the A5 and B5 pins of the first connector electrically connects to the multiplexer.

In one embodiment, the A2 and A3 pins of the first connector electrically connect to the multiplexer and the B2 and B3 pins of the first connector electrically connect to the multiplexer to communicate with SSTX0 pins of the upstream facing port through the multiplexer, and the B11 and B10 pins of the first connector electrically connect to the multiplexer and the A11 and A10 pins of the first connector electrically connect to the multiplexer to communicate with SSRX0 pins of the upstream facing port through the multiplexer.

In one embodiment, the A2 and A3 pins of the second connector electrically connect to SSTX1 pins of the first downstream facing port, the B11 and B10 pins of the second connector electrically connect to SSRX1 pins of the first downstream facing port, the B2 and B3 pins of the second connector electrically connect to SSTX2 pins of the second downstream facing port, and the A11 and A10 pins of the second connector electrically connect to SSRX2 pins of the second downstream facing port.

In one embodiment, the A6 pin of the first connector electrically connects to the B6 pin of the first connector and further electrically connects to a D0+ pin of the upstream facing port, the A7 pin of the first connector electrically connects to the B7 pin of the first connector and further electrically connects to a D0− pin of the upstream facing port, the A6 pin of the second connector electrically connects to a D1+ pin of the first downstream facing port, the A7 pin of the second connector electrically connects to a D1− pin of the first downstream facing port, the B6 pin of the second connector electrically connects to a D2+ pin of the second downstream facing port, and the B7 pin of the second connector electrically connects to a D2− pin of the second downstream facing port.

Accordingly, the extended and expanded USB 3.1 hub can facilitate a user to transfer the USB signal transmission, and the extended and expanded USB 3.1 hub can be operated with the power of the USB itself without an additional external power supply. At the same time, with the configuration of two downstream ports, data transmission of two USB components of an electronic device can be simultaneously performed, a power required for the electronic device can also be provided by the extended and expanded USB 3.1 hub, and therefore the electronic USB device can be operated more convenient.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a schematic perspective diagram showing an extended and expanded USB 3.1 hub according to one embodiment of the present invention; and

FIG. 2 illustrates a schematic circuit diagram showing an extended and expanded USB 3.1 hub according to one embodiment of the present invention.

### DETAILED DESCRIPTION OF THE PREFERRED EMBODIMENT

The following description is of the best presently contemplated mode of carrying out the present disclosure. This description is not to be taken in a limiting sense but is made merely for the purpose of describing the general principles of the invention. The scope of the invention should be determined by referencing the appended claims.

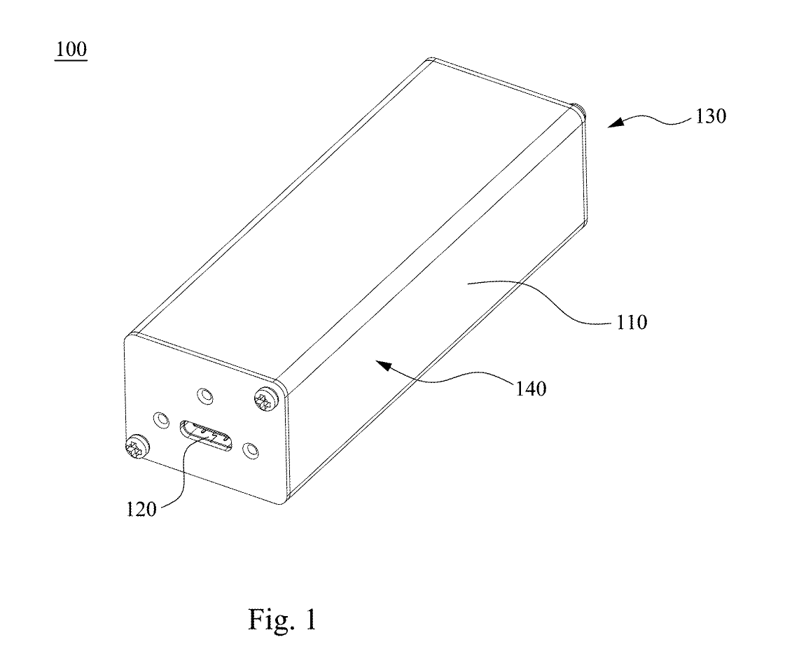

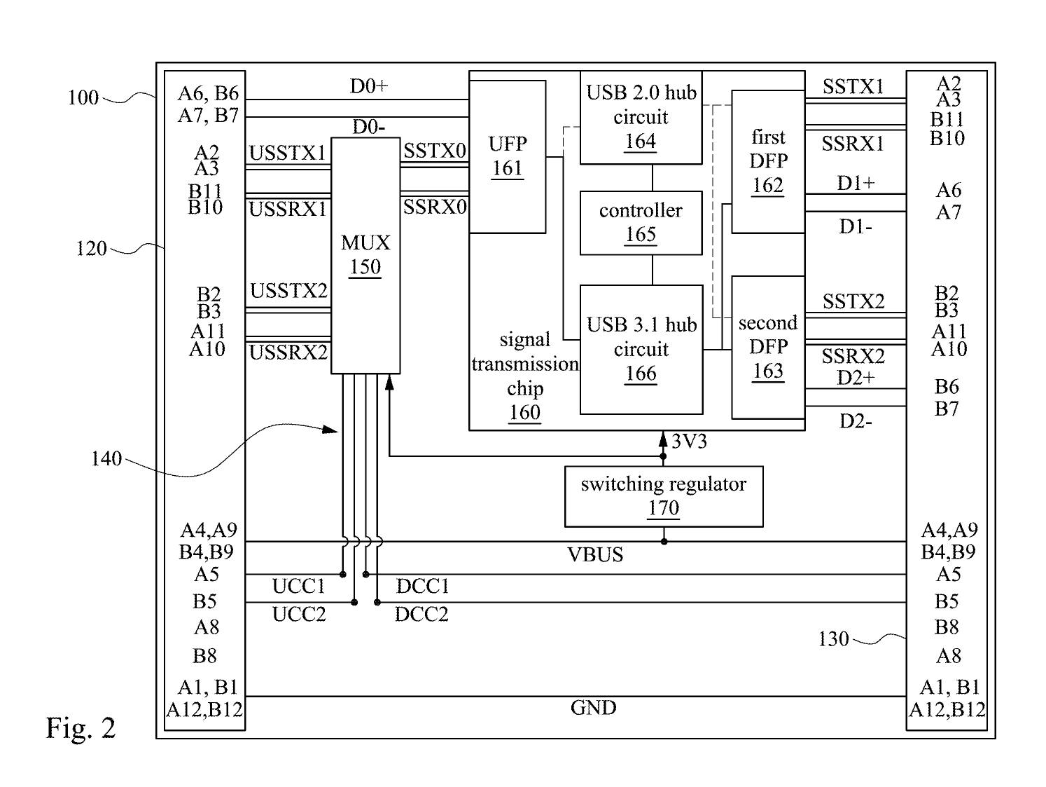

FIG. 1 illustrates a schematic perspective diagram showing an extended and expanded USB 3.1 hub according to one embodiment of the present invention and FIG. 2 illustrates a schematic circuit diagram thereof.

As shown in FIG. 1, the extended and expanded USB 3.1 hub 100 includes a housing 110, a first connector 120, a second connector 130 and a signal transmission module 140.

The first connector 120 and the second connector 130 are both installed on the housing 110, and electrically connect to the signal transmission module 140. In addition, the signal transmission module 140 is installed in the housing 110 to rectify and extend USB signals.

In one embodiment, the first connector 120 is a USB 3.1 Type-C connector. For example, the first connector 120 is located at an upstream port of the extended and expanded USB 3.1 hub 100 and is a connector for connecting a host, e.g. a host computer. In addition, the second connector 130 is also a USB 3.1 Type-C and is located at a downstream port of the extended and expanded USB 3.1 hub 100. The second connector 130 is a connector for connecting an electronic device, e.g. a camera or a hard disk.

Simultaneously referring to FIG. 2, the signal transmission module 140 includes a multiplexer (MUX) 150, a signal transmission chip 160 and a switching regulator 170. The multiplexer 150 electrically connects to the first connector 120, and the signal transmission chip 160 electrically connects to the multiplexer 150. In addition, the switching regulator 170 electrically connects to the signal transmission chip 160 and the multiplexer 150 to provide the required power for the signal transmission chip 160 and the multiplexer 150. In one embodiment, the multiplexer 150 is, for example, a multiplexer with configuration channel logic (CCL) control.

The signal transmission chip 160 of the extended and expanded USB 3.1 hub 100 further comprises an upstream facing port (UFP) 161, a USB 2.0 hub circuit 164, a controller 165, a USB 3.1 hub circuit 166, a first downstream facing port (DFP) 162 and a second downstream facing port (DFP) 163.

The USB 2.0 hub circuit 164 is located between the upstream facing port 161, the first downstream facing port 162 and the second downstream facing port 163 to electrically connect to the upstream facing port 161, the first downstream facing port 162 and the second downstream facing port 163.

The USB 3.1 hub circuit 166 is also located between the upstream facing port 161, the first downstream facing port 162 and the second downstream facing port 163 to electrically connect to the upstream facing port 161, the first downstream facing port 162 and the second downstream facing port 163. The controller 165 is, for example, a Micro-controller Unit (MCU) to electrically connect to the USB 2.0 hub circuit 164 and the USB 3.1 hub circuit 166, and controls the USB 2.0 hub circuit 164 and the USB 3.1 hub circuit 166 to allow an electronic device regardless of a USB 2.0 device or a USB 3.1 device communicating with a computer connected to the first connector 120 of the extended and expanded USB 3.1 hub 100.

In one embodiment, the USB device connected to the second connector 130 can be an electronic USB 3.1 Gen 2 device with 10 Gbps (gigabit per second) transmission rate.

In one embodiment, the USB device connected to the second connector 130 can be an electronic USB device having a USB 3.1 Gen 1 component with 5 Gbps transmission rate and a USB 3.1 Gen 2 component with 10 Gbps transmission rate.

In one embodiment, the USB device connected to the second connector 130 can be an electronic USB device having two USB 3.1 Gen 1 components with 5 Gbps transmission rate.

In one embodiment, the USB device connected to the second connector 130 can be an electronic USB device having two USB 3.2 Gen 1 components with 10 Gbps transmission rate.

The USB device connected to the second connector 130 can be an electronic USB device having two USB components with same transmission rates or different transmission rates in one electronic device without departing from the spirit and scope of the invention.

In addition, the computer connected to the first connector 120 is a computer with at least one USB 3.1 port.

The first connector 120 and the second connector 130 respectively include A1-A12 pins and B1-B12 pins.

The A4, A9, B4 and B9 pins of the first connector 120 electrically connect to the A4, A9, B4 and B9 pins of the second connector 130, and further electrically connect to the switching regulator 170. Therefore, the switching regulator 170 can get the power form the A4, A9, B4 and B9 pins and supply a desired power, e.g. 3.3V or 5V power, to the signal transmission chip 160 and the multiplexer 150. The extended and expanded USB 3.1 hub 100 can be operated with the USB power from the computer to rectify the USB signals for extending the signal transmission distance without any other additional power supply. Therefore, the transmission distance of the USB signals can effectively be increased.

In addition, the A5 pin and B5 pin of the first connector 120 electrically connect to the multiplexer 150. Therefore, after a host computer is connected to the first connector 120 and the electronic device is connected to the second connector 130, the extended and expanded USB 3.1 hub 100 can recognize the host computer and the electronic device according to the UCC1 and UCC2 signals and further control the multiplexer 150 to adjust the transmission path thereof. In addition, the A5 pin and B5 pin of the second connector 130 electrically connect to the multiplexer 150 and transmit the DCC1 and DCC2 signals therebetween. Therefore, the extended and expanded USB 3.1 hub 100 can directly deliver the power from the provider side to the consumer side.

Furthermore, the A2 and A3 pins of the first connector 120 electrically connect to the multiplexer 150, the B2 and B3 pins of the first connector 120 electrically connect to the multiplexer 150 to transmit the data through SSTX0 pins of the upstream facing port 161, and switch the signal transmission path with the multiplexer 150.

In addition, the B11 and B10 pins of the first connector 120 electrically connect to the multiplexer 150, and the A11 and A10 pins of the first connector 120 electrically connect to the multiplexer 150 to transmit the data with SSRX0 pins of the upstream facing port 161 and the multiplexer 150, and switch the signal transmission path with the multiplexer 150.

Further describing the circuit configuration of the second connector 130, the A2 and A3 pins of the second connector 130 electrically connect to SSTX1 pins of the first downstream facing port 162, the B11 and B10 pins of the second connector 130 electrically connect to SSRX1 pins of the first downstream facing port 162, the B2 and B3 pins of the second connector 130 electrically connect to SSTX2 pins of the second downstream facing port 163, and the A11 and A10 pins of the second connector 130 electrically connect to SSRX2 pins of the second downstream facing port 163. Therefore, with the configuration of the first downstream facing port 162 and the second downstream facing port 163, a USB cable can simultaneously connect to two USB components of an electronic device and perform the data transmission. That is, two hard disks in an external hard disk device, can simultaneously use a single USB cable to connect to the extended and expanded USB 3.1 hub 100, and the data thereof is transmitted to the host computer so as to effectively increase the data transmission efficiency of the electronic USB device.

In addition, because the extended and expanded USB 3.1 hub 100 is also compatible with USB 2.0 electronic devices, the A6 pin of the first connector 120 electrically connects to the B6 pin of the first connector 120 and further electrically connects to the D0+ pin of the upstream facing port 161, the A7 pin of the first connector 120 electrically connects to the B7 pin of the first connector 120 and electrically connects to the D0− pin of the upstream facing port 161, the A6 pin of the second connector 130 connects to the D1+ pin of the first downstream facing port 162, the A7 pin of the second connector 130 electrically connects to the D1− pin of the first downstream facing port 162, the B6 pin of the second connector 130 electrically connects to the D2+ pin of the second downstream facing port 163, and the B7 pin of the second connector 130 electrically connects to the D2− pin of the second downstream facing port 163. Therefore, the first downstream facing port 162 and the second downstream facing port 163 of the extendable and expanded USB 3.1 hub 100 can also connect to two USB 2.0 components of an electronic device for signal transmission at the same time.

In addition, the A1, B1, A12, B12 pins of the first connector 120 are ground pins, and are connected to the A1, B1, A12, and B12 pins of the second connector 130.

Accordingly, the extended and expanded USB 3.1 hub can facilitate a user to transfer the USB signal transmission, and the extended and expanded USB 3.1 hub can be operated with the power of the USB itself without an additional external power supply. At the same time, with the configuration of two downstream ports, data transmission of two USB components of an electronic device can be simultaneously performed, a power required for the electronic device can also be provided by the extended and expanded USB 3.1 hub, and therefore the electronic USB device can be operated more convenient.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. An extended and expanded USB 3.1 hub, comprising:
a housing;
a signal transmission module installed in the housing;
a first connector installed on the housing to electrically connect to the signal transmission module; and
a second connector installed on the housing to electrically connect to the signal transmission module, wherein the second connector is used for connecting an electronic device, and the first connector and the second connector are Type-C connectors.

2. The extended and expanded USB 3.1 hub of claim 1, wherein the first connector and the second connector are USB 3.1 Type-C connectors.

3. The extended and expanded USB 3.1 hub of claim 1, wherein the signal transmission module comprises:
a multiplexer (multiplexer) electrically connecting to the first connector;
a signal transmission chip electrically connecting to the multiplexer; and
a switching regulator electrically connecting to the signal transmission chip and the multiplexer, wherein the multiplexer is a multiplexer with multiplexer with configuration channel logic control.

4. The extended and expanded USB 3.1 hub of claim 3, wherein the signal transmission chip comprises:
an upstream facing port;
a USB 2.0 hub circuit electrically connecting to the upstream facing port;
a controller electrically connecting to the USB 2.0 hub circuit;
a USB 3.1 hub circuit electrically connecting to the controller and the upstream facing port;
a first downstream facing port electrically connecting to the USB 2.0 hub circuit and the USB 3.1 hub circuit; and
a second downstream facing port electrically connecting to the USB 2.0 hub circuit and the USB 3.1 hub circuit.

5. The extended and expanded USB 3.1 hub of claim 4, wherein the first connector and the second connector respectively comprise A1-A12 pins and B1-B12 pins.

6. The extended and expanded USB 3.1 hub of claim 5, wherein the A4, A9, B4 and B9 pins of the first connector electrically connect to the A4, A9, B4 and B9 pins of the second connector, and further electrically connect to the switching regulator.

7. The extended and expanded USB 3.1 hub of claim 6, wherein the A5 and B5 pins of the first connector electrically connects to the multiplexer.

8. The extended and expanded USB 3.1 hub of claim 7, wherein the A2 and A3 pins of the first connector electrically connect to the multiplexer and the B2 and B3 pins of the first connector electrically connect to the multiplexer to communicate with SSTX0 pins of the upstream facing port through the multiplexer, and the B11 and B10 pins of the first connector electrically connect to the multiplexer and the A11 and A10 pins of the first connector electrically connect to the multiplexer to communicate with SSRX0 pins of the upstream facing port through the multiplexer.

9. The extended and expanded USB 3.1 hub of claim 8, wherein the A2 and A3 pins of the second connector electrically connect to SSTX1 pins of the first downstream facing port, the B11 and B10 pins of the second connector electrically connect to SSRX1 pins of the first downstream facing port, the B2 and B3 pins of the second connector electrically connect to SSTX2 pins of the second downstream facing port, and the A11 and A10 pins of the second connector electrically connect to SSRX2 pins of the second downstream facing port.

10. The extended and expanded USB 3.1 hub of claim 5, wherein the A6 pin of the first connector electrically connects to the B6 pin of the first connector and further electrically connects to a D0+ pin of the upstream facing port, the A7 pin of the first connector electrically connects to the B7 pin of the first connector and further electrically connects to a D0− pin of the upstream facing port, the A6 pin of the second connector electrically connects to a D1+ pin of the first downstream facing port, the A7 pin of the second connector electrically connects to a D1− pin of the first downstream facing port, the B6 pin of the second connector electrically connects to a D2+ pin of the second downstream facing port, and the B7 pin of the second connector electrically connects to a D2− pin of the second downstream facing port.
